(19) United States
(12) Patent Application Publication
(10) Pub. No.: US 2023/0379731 A1
(43) Pub. Date: Nov. 23, 2023

(54) Enhanced OpenRAN-MEC Info Exchange Solution

(71) Applicant: Parallel Wireless, Inc., Nashua, NH (US)

(72) Inventors: Amit Ghadge, Pune (IN); David Khemelevsky, Alfei-Menashe (IL); Gajanana Garuda, Bengaluru (IN)

(21) Appl. No.: 18/321,768

(22) Filed: May 22, 2023

Related U.S. Application Data
(60) Provisional application No. 63/344,089, filed on May 20, 2022.

(51) Int. Cl. H04W 24/02

(52) U.S. Cl. CPC H04W 24/02

(57) ABSTRACT

A method providing Open Radio Access Network (RAN)—Multi-Access Edge Computing (MEC) information exchange is disclosed, the method comprising: providing an xApp for RAN-MEC information exchange; providing an rApp for RAN-MEC information exchange; acting, by an RM Application Programming Interface (API) service, as an aggregation point in MEC platform; exposing aggregated information from the RM API to a MEC application; and leveraging information shared by RAN functions over an O1 interface or over an E2 interface.

### CROSS-REFERENCE TO RELATED APPLICATIONS

This application claims priority under 35 U.S.C. § 119(e) to U.S. Provisional Pat. App. No. 63/344,089, filed May 20, 2022, titled “Enhanced OpenRAN-MEC Information Exchange Solution” which is hereby incorporated by reference in its entirety for all purposes. This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

Multi-Access Edge Computing (MEC) is recognized as one of the key pillars for meeting the Key Performance Indexes (KPIs) demanded from 5G, especially for latency and bandwidth efficiency. In addition, it plays in important role in transformation of telecommunication network into versatile service platform for industry and other customer segments. MEC is gathering pace with 4G/5G networks with the intent to go after use cases that need low latency (e.g. less than 10 milli-seconds end-to-end latency) support. In a traditional mobile network with Centralized Packet Core network and Centralized Application server the average latency in the datapath is in the range of 100-200 milli-seconds. With MEC solution, that encompasses the Core as well as the application functions, latency is drastically reduced. This enables operators to go after newer revenue opportunities which were not possible earlier due to the operator network not being able to support or had the capability to support Ultra-Low Latency (URLLC) requirement of milliseconds needed by these latency sensitive applications. URLLC use cases include Industrial Robotics, immersive AR/VR, Gaming, Autonomous vehicles and others.

### SUMMARY

The presently described Enhanced openRAN-MEC information exchange solution provides improved processing and services. In one embodiment, a method of providing Open Radio Access Network (RAN)—Multi-Access Edge Computing (MEC) information exchange includes providing an xApp for RAN-MEC information exchange; providing an rApp for RAN-MEC information exchange; acting, by an RM Application Programming Interface (API) service, as an aggregation point in MEC platform; exposing the aggregated information to a MEC application; and leveraging information shared by RAN functions over an O1 interface and over an E2 interface.

### BRIEF DESCRIPTION OF THE DRAWINGS

FIG. 1 is a schematic diagram of MEC (mobile edge compute) and centralized/cloud RAN, in accordance with some embodiments.

FIG. 2 is a schematic diagram of an ORAN deployment, in accordance with some embodiments.

FIG. 3 is a schematic architecture diagram showing application deployment platforms for OpenRAN and MEC, in accordance with some embodiments.

FIG. 4 is a schematic network architecture diagram for 3G and other-G prior art networks, in accordance with some embodiments.

FIG. 5 is an enhanced eNodeB for performing the methods described herein, in accordance with some embodiments.

FIG. 6 is a coordinating server for providing services and performing methods as described herein, in accordance with some embodiments.

FIG. 7 is a further schematic network architecture diagram, in accordance with some embodiments.

### DETAILED DESCRIPTION

Mobile networks with RAN networks that are closer to the end-user can expose value added information to the MEC application that can help applications provide value added services to the end user. Solution proposed in this submission provides a simpler, cleaner and more efficient way to exchange this info between the RAN and the MEC solution. Mobile networks with RAN networks that are closer to the end-user can expose value added information, pertaining to the end-user, to the MEC application that can help applications provide value added services to the end user.

Open RAN is the movement in wireless telecommunications to disaggregate hardware and software and to create open interfaces between them. Open RAN also disaggregates RAN into components like RRH (Remote Radio Head), DU (Distributed Unit), CU (Centralized Unit), Near-RT (Real-Time) and Non-RT RIC(RAN Intelligence Controller). Below is the Open RAN architecture as defined by ORAN alliance:

CU function is split into CU-CP (Control Plane) and CU-UP (User Plane) function to provide Control and User Plane separation. Open RAN solution needs to support: open interfaces between different functions; software based functions; cloud native functions; intelligence support via support for xApps/rApps; third Party RRHs; disaggregated functions; White Box COTS hardware support; and Data Path separated from Control plane traffic.

Control & User plane separation has following advantages: separation helps in having separate Data centers tailored to function needs; and data traffic traverses User Plane Path from RU->DU->CU-UP->Core->MEC Application.

CU-CP function handles the control plane traffic and CU-UP function handles the user plane data traffic. Any user plane traffic either in uplink or downlink passes through both DU & CU-UP function. CU-UP function relays the traffic between DU and the Core network and any user plane traffic processing is done by CU-UP.

With 4G and 5G there is a need to support ultra-low latency use cases or applications. Latency of few milli-seconds is one of the need for applications like Industrial robotics, eHealth, Autonomous vehicles and so on. In order to do this it is necessary to reduce the number of hops in the user plane path. More the number of hops in the path higher the latency. MEC solutions help in reducing the latency drastically.

Mobile networks with RAN networks that are closer to the end-user can expose value added information, pertaining to the end-user, to the MEC application that can help applications provide value added services to the end user. Solution proposed in this submission provides a simpler cleaner and more efficient way to exchange this info between the RAN and the MEC

### Solution

Currently there are proprietary and inefficient way of exchanging this info. Proprietary interfaces need to be supported in RAN (CU) to expose the info to MEC solution. This can lead to interoperability issues between MEC and RAN and add complexity to RAN CU function. In addition, CU may not have all the information which can assist the MEC solution. There needs to be some central entity which has more information with respect to UEs location, type of application, UE's performance, coverage etc.

### Solution to Problem

The enhanced OpenRAN-MEC Info exchange solution described here aims to provide a simpler, cleaner and more efficient way to exchange this information between the RAN and the MEC solution.

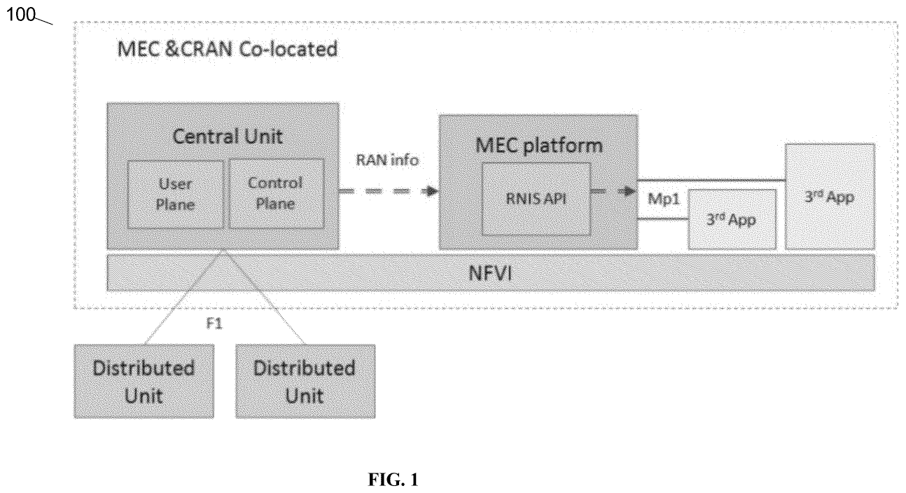

FIG. 1 is a schematic diagram of MEC (mobile edge compute) and centralized/cloud RAN, in accordance with some embodiments.

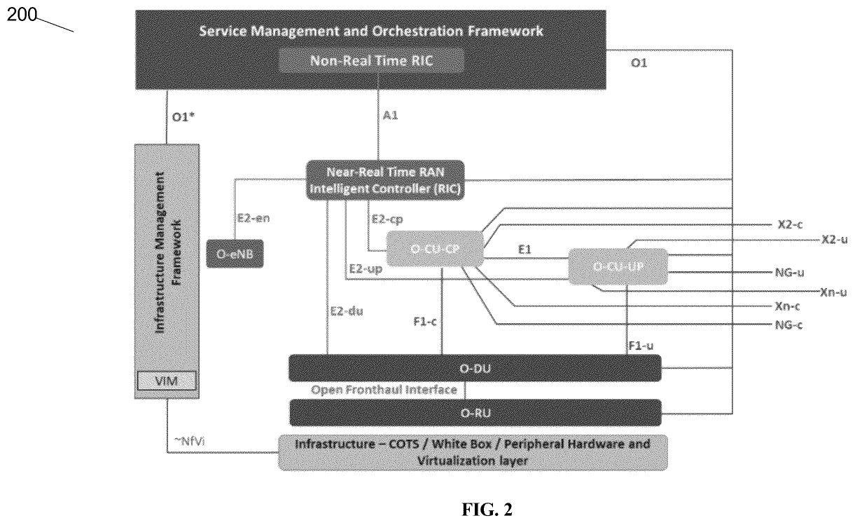

FIG. 2 is a schematic diagram of an ORAN deployment, in accordance with some embodiments.

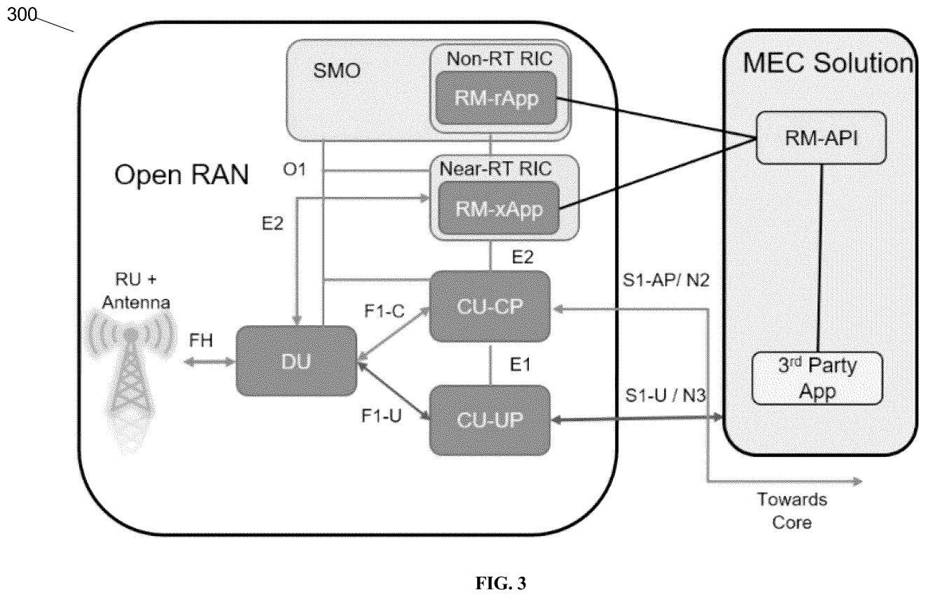

FIG. 3 is a schematic architecture diagram showing application deployment platforms for OpenRAN and MEC, in accordance with some embodiments.

Enhanced OpenRAN-MEC Info exchange solution proposes following solution: introduce xApp/rApp for RAN-MEC info exchange; RM API service in MEC solution acts as the aggregation point in MEC platform before exposing it to the MEC application; uses standard ORAN interfaces on RAN functions instead of need for proprietary interfaces; leverage information shared by RAN functions like CU/DU/RU over O1 & E2; and RM-API could for RNIS, Location, UE Identity or Bandwidth API service as prescribed by ETSI.

The RAN-MEC info exchange will be done as shown in FIG. 3.

FIG. 3 shows the following four software deployment environments: RM-xApp-RAN-MEC Info exchange xApp; RM-TApp-RAN-MEC Info exchange rApp; RM-API-RAN-MEC Info exchange API service in MEC Platform; and 3rd Party App-MEC application. xApps and rApps are distinguished by where in the architecture they are executed, in some embodiments. xApps and rApps are network automation tools. They maximize the radio network's operational efficiency. rApps are specialized microservices operating on the non-RT RIC. xApps and rApps may provide control and management features and functionality. xApps are hosted on the near RT RIC and typically are used to optimize radio spectrum efficiency. While xApps and rApps are defined with respect to the 5G standard and OpenRAN, the presently disclosed architecture enables the use of these apps for other RATs, including 2G, 3G, and 4G.

RM-xApp and RM-rApp are the new xApp and rApp that adhere to the ORAN standards and leverage the Open APIs exposed by Near-RT RIC and Non-RT RIC frameworks. They can collect the needed info from CU or DU over O1 or E2 interface and pass it on to the RM-API service in the MEC solution. RM-xApp, RM-rApp and RM-API can be owned by MEC solution vendor, RAN vendor or a 3rd Party vendor. Interface between xApp/rApp and RM-API can be implementation specific. RM-API service in MEC solution exposes the APIs towards third Party MEC application as defined and standardized by ETSI MEC specs. MEC solution here consists of a MEC platform and the 3rd party MEC application as applicable.

Solution proposed exceeds and extends existing standards. Solution proposed has both pros and cons associated with and thus extends the standards as proposed in 3GPP & ORAN.

Advantages of the proposed Enhanced OpenRAN-MEC Info exchange solution are provides multivendor interoperable solution; uses standard ORAN interfaces on RAN functions instead of need for proprietary interfaces; leverage info shared by RAN functions like CU/DU/RU over O1 & E2; solution is simple, cleaner and efficient; reduces complexity on RAN functions like CU and DU to expose RAN information; the data that can be gathered by rApps and xApps are unlimited due to the hierarchical architecture of the RIC and it can provide both realtime and non-realtime data based on the usecases; and it could be extended to more advanced requirements of MEC in future since it has a centralized view of all the serving and neighboring areas.

Disadvantages of the proposed Enhanced OpenRAN-MEC Info exchange solution are RAN info exchanged will typically go via Centralized RIC. This could add latency in exchange of RAN information. This again can vary based on the deployment scenario that decide where the RIC functions are placed in the network.

Architecture Diagram

With the solution being proposed the new Enhanced OpenRAN-MEC Info exchange solution will be as shown in FIG. 3.

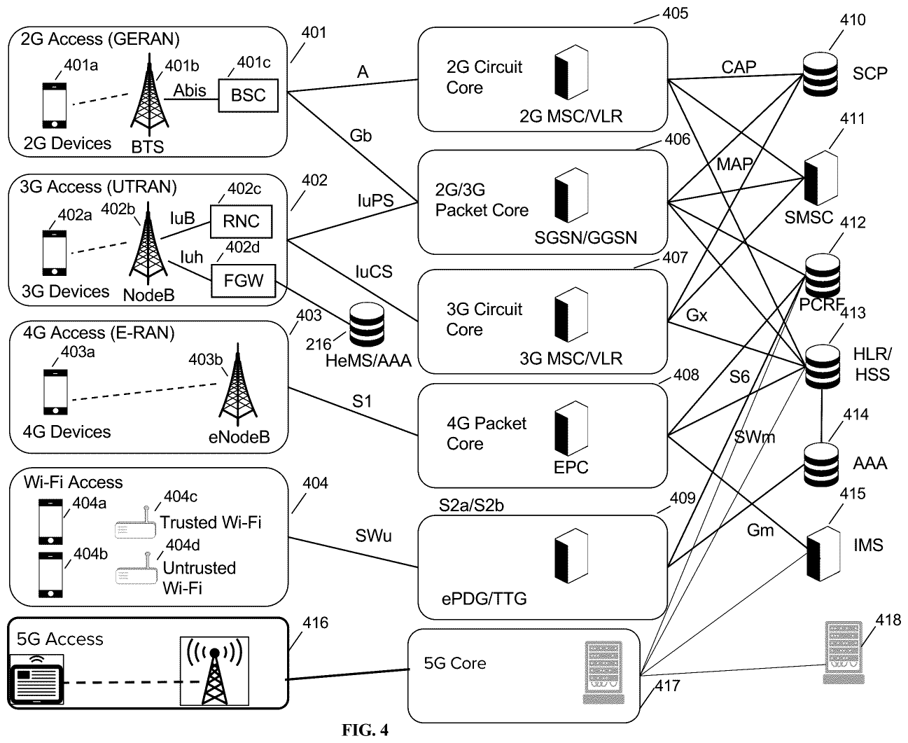

FIG. 4. Shown above is a schematic network architecture diagram for 3G and other-G prior art networks. The diagram shows a plurality of “Gs,” including 2G, 3G, 4G, 5G and Wi-Fi. 2G is represented by GERAN 401, which includes a 2G device 401a, BTS 401b, and BSC 401c. 3G is represented by UTRAN 402, which includes a 3G UE 402a, nodeB 402b, RNC 402c, and femto gateway (FGW, which in 3GPP namespace is also known as a Home nodeB Gateway or HNBGW) 402d. 4G is represented by EUTRAN or E-RAN 403, which includes an LTE UE 403a and LTE eNodeB 403b. Wi-Fi is represented by Wi-Fi access network 404, which includes a trusted Wi-Fi access point 404c and an untrusted Wi-Fi access point 404d. The Wi-Fi devices 404a and 404b may access either AP 404c or 404d. In the current network architecture, each “G” has a core network. 2G circuit core network 405 includes a 2G MSC/VLR; 2G/3G packet core network 406 includes an SGSN/GGSN (for EDGE or UMTS packet traffic); 3G circuit core 407 includes a 3G MSC/VLR; 4G circuit core 408 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 430, the SMSC 431, PCRF 432, HLR/HSS 433, Authentication, Authorization, and Accounting server (AAA) 434, and IP Multimedia Subsystem (IMS) 435. An HeMS/AAA 436 is present in some cases for use by the 3G UTRAN. The diagram is used to indicate schematically the basic functions of each network as known to one of skill in the art, and is not intended to be exhaustive. For example, 5G core 417 is shown using a single interface to 5G access 416, although in some cases 5G access can be supported using dual connectivity or via a non-standalone deployment architecture.

Noteworthy is that the RANs 401, 402, 403, 404 and 436 rely on specialized core networks 405, 406, 407, 408, 409, 437 but share essential management databases 430, 431, 432, 433, 434, 435, 438. More specifically, for the 2G GERAN, a BSC 401c is required for Abis compatibility with BTS 401b, while for the 3G UTRAN, an RNC 402c is required for Iub compatibility and an FGW 402d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

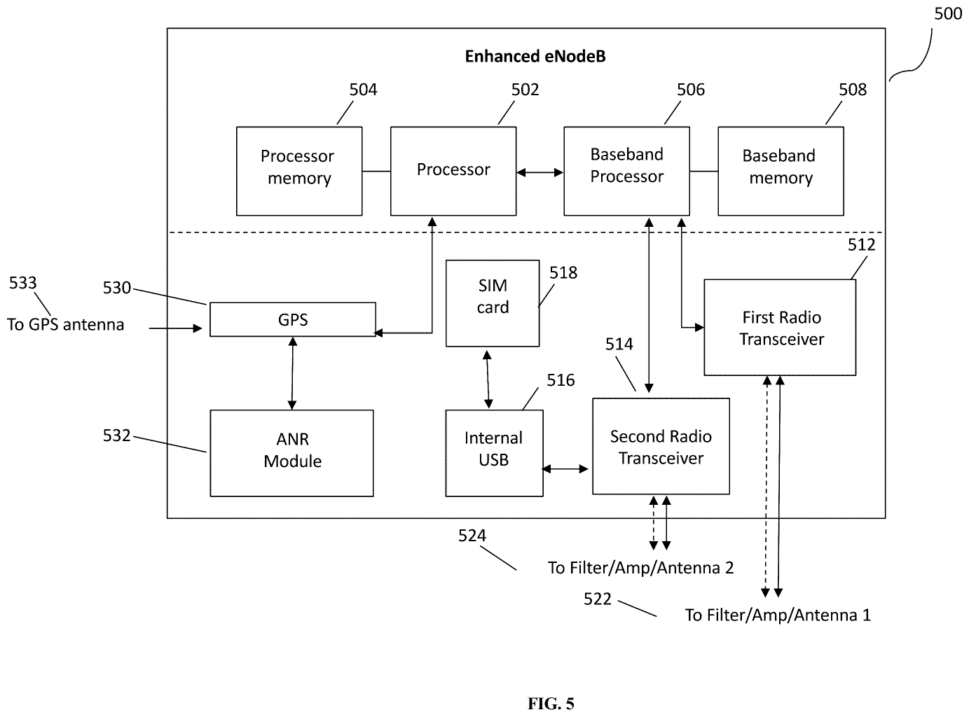

FIG. 5 is an enhanced eNodeB for performing the methods described herein, in accordance with some embodiments. eNodeB 500 may include processor 502, processor memory 504 in communication with the processor, baseband processor 506, and baseband processor memory 508 in communication with the baseband processor. Mesh network node 500 may also include first radio transceiver 512 and second radio transceiver 514, internal universal serial bus (USB) port 516, and subscriber information module card (SIM card) 518 coupled to USB port 516. In some embodiments, the second radio transceiver 514 itself may be coupled to USB port 516, and communications from the baseband processor may be passed through USB port 516. The second radio transceiver may be used for wirelessly backhauling eNodeB 500.

Processor 502 and baseband processor 506 are in communication with one another. Processor 502 may perform routing functions, and may determine if/when a switch in network configuration is needed. Baseband processor 506 may generate and receive radio signals for both radio transceivers 512 and 514, based on instructions from processor 502. In some embodiments, processors 502 and 506 may be on the same physical logic board. In other embodiments, they may be on separate logic boards.

Processor 502 may identify the appropriate network configuration, and may perform routing of packets from one network interface to another accordingly. Processor 502 may use memory 504, in particular to store a routing table to be used for routing packets. Baseband processor 506 may perform operations to generate the radio frequency signals for transmission or retransmission by both transceivers 510 and 512. Baseband processor 506 may also perform operations to decode signals received by transceivers 512 and 514. Baseband processor 506 may use memory 508 to perform these tasks.

The first radio transceiver 512 may be a radio transceiver capable of providing LTE eNodeB functionality, and may be capable of higher power and multi-channel OFDMA. The second radio transceiver 514 may be a radio transceiver capable of providing LTE UE functionality. Both transceivers 512 and 514 may be capable of receiving and transmitting on one or more LTE bands. In some embodiments, either or both of transceivers 512 and 514 may be capable of providing both LTE eNodeB and LTE UE functionality. Transceiver 512 may be coupled to processor 502 via a Peripheral Component Interconnect-Express (PCI-E) bus, and/or via a daughtercard. As transceiver 514 is for providing LTE UE functionality, in effect emulating a user equipment, it may be connected via the same or different PCI-E bus, or by a USB bus, and may also be coupled to SIM card 518. First transceiver 512 may be coupled to first radio frequency (RF) chain (filter, amplifier, antenna) 522, and second transceiver 514 may be coupled to second RF chain (filter, amplifier, antenna) 524.

SIM card 518 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 500 is not an ordinary UE but instead is a special UE for providing backhaul to device 500.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 512 and 514, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 502 for reconfiguration.

A GPS module 530 may also be included, and may be in communication with a GPS antenna 532 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 532 may also be present and may run on processor 502 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

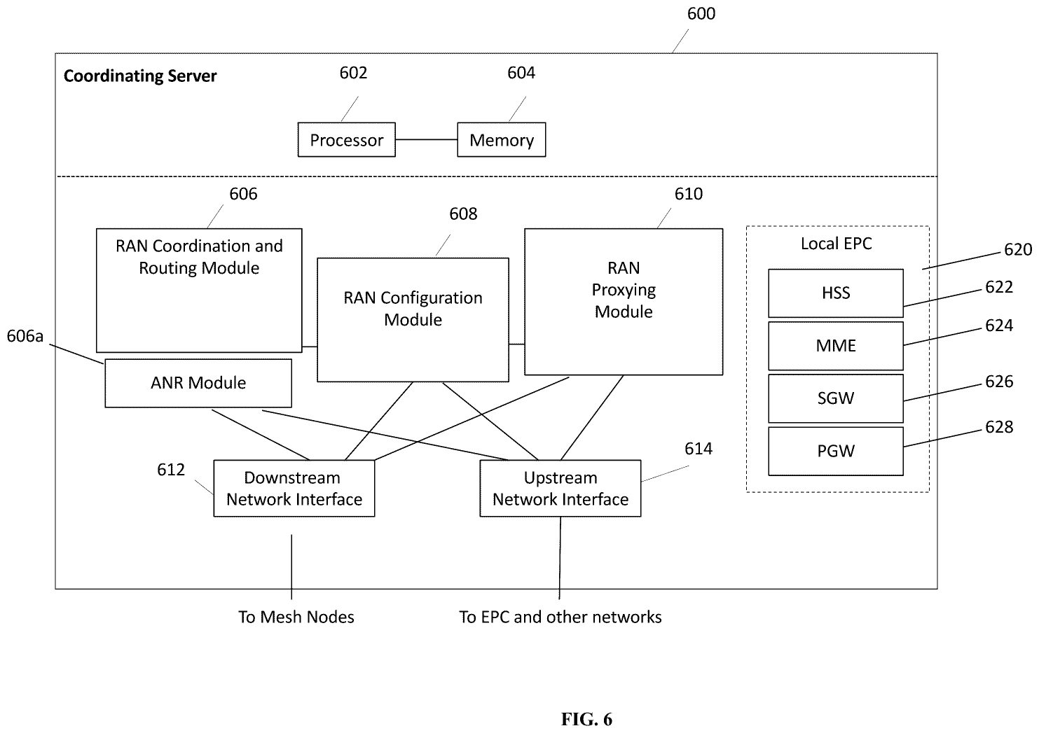

FIG. 6 is a coordinating server for providing services and performing methods as described herein, in accordance with some embodiments. Coordinating server 600 includes processor 602 and memory 604, which are configured to provide the functions described herein. Also present are radio access network coordination/routing (RAN Coordination and routing) module 606, including ANR module 606a, RAN configuration module 608, and RAN proxying module 610. The ANR module 606a may perform the ANR tracking, PCI disambiguation, ECGI requesting, and GPS coalescing and tracking as described herein, in coordination with RAN coordination module 606 (e.g., for requesting ECGIs, etc.). In some embodiments, coordinating server 600 may coordinate multiple RANs using coordination module 606. In some embodiments, coordination server may also provide proxying, routing virtualization and RAN virtualization, via modules 610 and 608. In some embodiments, a downstream network interface 612 is provided for interfacing with the RANs, which may be a radio interface (e.g., LTE), and an upstream network interface 614 is provided for interfacing with the core network, which may be either a radio interface (e.g., LTE) or a wired interface (e.g., Ethernet).

Coordinator 600 includes local evolved packet core (EPC) module 620, for authenticating users, storing and caching priority profile information, and performing other EPC-dependent functions when no backhaul link is available. Local EPC 620 may include local HSS 622, local MME 624, local SGW 626, and local PGW 628, as well as other modules. Local EPC 620 may incorporate these modules as software modules, processes, or containers. Local EPC 620 may alternatively incorporate these modules as a small number of monolithic software processes. Modules 606, 608, 610 and local EPC 620 may each run on processor 602 or on another processor, or may be located within another device.

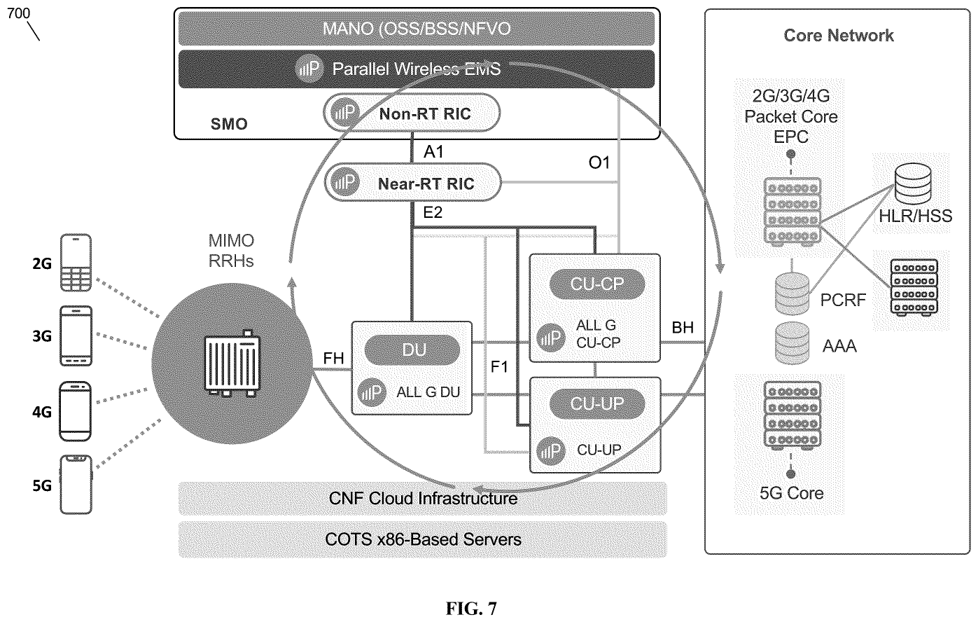

FIG. 7 is a schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users.

As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interwokring processes or which may involve supporting a subset of available commands for a RAT, in some embodiments.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to 5G networks, LTE-compatible networks, to UMTS-compatible networks, to 2G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Features of one embodiment may be used in another embodiment. Various steps as described in the figures and specification may be added or removed from the processes described herein, and the steps described may be performed in an alternative order, consistent with the spirit of the invention, limited only by the claims which follow.

1. A method providing Open Radio Access Network (RAN)—Multi-Access Edge Computing (MEC) information exchange, the method comprising:
providing an xApp for RAN-MEC information exchange;
providing an rApp for RAN-MEC information exchange;
acting, by an RM Application Programming Interface (API) service, as an aggregation point in MEC platform;
exposing aggregated information from the RM API to a MEC application; and
leveraging information shared by RAN functions over an O1 interface or over an E2 interface.
